(19) United States
(12) Patent Application Publication
(10) Pub. No.: US 2015/0046356 A1
(43) Pub. Date: Feb. 12, 2015

(54) IDENTIFICATION OF SKILLS GAPS BASED ON PREVIOUS SUCCESSFUL HIRES

(71) Applicant: Oracle International Corporation, Redwood Shores, CA (US)

(72) Inventors: Martin Millmore, Caversham (GB); Dinesh Arora, Cupertino, CA (US)

(73) Assignee: Oracle International Corporation, Redwood Shores, CA (US)

(21) Appl. No.: 13/962,406

(22) Filed: Aug. 8, 2013

(51) Int. Cl. G06Q 10/10

(52) U.S. Cl. CPC G06Q 10/1053
USPC 705/321

(57) ABSTRACT

A system and method for providing career-related information. An example method includes determining a first set of one or more jobs based on one or more criteria; accessing successful hire data pertaining to one or more jobs of the first set of one or more jobs; and employing the successful hire data to provide one or more natural language suggestions in response thereto. The successful hire data may represent data characterizing one or more persons that have been previously hired to the one or more jobs and who is associated with a performance metric that surpasses a threshold. In a more specific embodiment, the method further includes comparing user data with the successful hire data, and using comparison results to provide the one or more natural language suggestions in response thereto.

### CROSS REFERENCES TO RELATED APPLICATIONS

This application is related to the following application, U.S. patent application Ser. No. 13/371,279, entitled MODELING CAREER PATH BASED ON SUCCESSFUL INDIVIDUALS IN AN ORGANIZATION (Atty. Docket No. ORACP0051-ORA110233-US-NP), filed on Feb. 10, 2012, which is hereby incorporated by reference, as if set forth in full in this specification:

### BACKGROUND

The present application relates to software and more specifically to systems, user interfaces, and methods for providing career-related information, such as information that facilitates ascertaining or analyzing job applicant qualifications or suitability for a particular job or position.

Software that provides career-related information is employed in various demanding applications, including career development websites, employee-employer job matching websites, enterprise talent management software, and so on. Such applications often demand effective methods for collecting and presenting pertinent career-related information for use by prospective job applicants, recruiters, and enterprises.

Efficient and user friendly systems and methods for presenting career-related information are particularly important for prospective job applicants, e.g., persons seeking job positions for which they are not yet qualified, but lack information or guidance as to how to become qualified.

Conventionally, prospective job applicants may have access to job advertisements, general job literature, and career counselor advice. However, such information sources often provide terse, vague, generic, and/or generalized job descriptions and/or career advice. Accordingly, job seekers typically lack detailed information and access to unwritten job requirements or considerations that may be useful for informed career decision making.

Such lack of information may lead to inefficiencies, whereby both job candidates and enterprises may suffer when overly qualified persons or under qualified persons work in certain positions. Furthermore, enterprise recruiting costs may undesirably increase when large numbers of inappropriately qualified applicants apply for a position.

### SUMMARY

An example method facilitates providing career-related information to recruiters, prospective job applicants, employers, and so on. The example method includes determining a first set of one or more jobs based on one or more criteria; accessing successful hire data pertaining to one or more jobs of the first set of one or more jobs; and employing the successful hire data to provide one or more natural language suggestions in response thereto.

The successful hire data may represent data characterizing one or more persons who have been previously hired to the one or more jobs and who are associated with performance metrics that surpass predetermined thresholds. Alternatively, or in addition, the successful hire data may represent data characterizing one or more persons who have been previously hired to a particular job.

In a more specific embodiment, which is adapted for use by a prospective job applicant (i.e., candidate), the method further includes receiving a query specifying one or more job search criteria; determining a set of one or more jobs based on the job search criteria; ascertaining user data, such as user qualifications, e.g., experience, employment history, education, certifications, skill levels, performance ratings, awards, and so on; obtaining successful hire data pertaining to one or more successful hires associated with one or more jobs of the set of jobs; and employing the user data and the successful hire data to generate one or more suggestions in response thereto.

The example method may further include comparing the user data with the successful hire data and providing comparison results in response thereto; and using the comparison results to provide the one or more suggestions in response thereto. The one or more suggestions may include natural language output that provides user instructions indicating how a user may become better qualified to become a successful hire for a particular job. The natural language output may further include an estimate of a probability that the user will be hired for a particular job currently and after the user obtains additional job qualifications specified via the one or more suggestions.

The job search criteria may include a job description, answers to a questionnaire, and so on. Some of the search criteria may be included among the user data used for comparison analysis with reference to successful hire data. The example method may further include employing text matching functionality to match words included among the search criteria with text associated with each job being searched, and then selectively including one or more jobs among search results in response to the text matching.

The step of ascertaining user data may include retrieving data pertaining to one or more characteristics (e.g., job qualifications) of the user from an enterprise database. The step of ascertaining user data may further include retrieving data pertaining to one or more characteristics of the user from one or more websites that include a user profile containing career-related information pertaining to the user. The career-related information may include an indication of one or more user job qualifications.

The step of obtaining successful hire data my include accessing one or more databases that store historical information pertaining to employee performance. The successful hire data may include one or more indications of a level of qualification of a person who has been hired to work at a job and who has exhibited a performance, as measured via a performance metric, which exceeds a threshold.

The comparison results may include an indication of a qualification gap (e.g., a skill gap, experience gap, etc.) between one or more qualifications of the user and one or more qualifications of one or more successful hires or collection of successful hires (e.g., and average of successful hire qualifications). The example method may further include estimating a qualification level most likely to result in the user being hired to a particular job based on a distribution of qualification levels of successful hires for the particular job.

The example method may further include determining a first value of a job qualification associated with a user and a second value of a job qualification associated with one or more successful hires, and displaying a visualization depicting a difference between the first value and the second value. A second visualization may indicate one or more jobs of the first set of one or more jobs in association with one or more measurements of job qualifications of a user and one or more measurements of job qualifications of one or more successful hires.

Hence, certain embodiments discussed herein facilitate providing career-related information and advice or suggestions to recruiters, prospective job applicants or candidates, and so on, based on job data, prospective applicant data, and data pertaining to previously successful employees or workers, i.e., successful hires.

Accordingly, important career-related information (e.g., unspoken or unwritten job requirements, characteristics, and/or other factors), which may have been previously unrecorded or obscure and not provided via a job advertisement or known to a career advisor, may now be readily accessible to recruiters and prospective job applicants via concise natural language advice, visualizations, and/or other mechanisms. Such information may facilitate informed career decision making.

Furthermore, such information may be particularly useful to enterprises, such as those with recruiting departments and/or those hosting job-search databases or related functions. For example, use of certain embodiments discussed herein may encourage job candidates to visit a job website; thereby attracting talent from a wider talent pool. Furthermore, such embodiments may reduce numbers of inappropriately qualified applicants applying to certain jobs, thereby potentially reducing requisite recruiting budgets.

A further understanding of the nature and the advantages of particular embodiments disclosed herein may be realized by reference of the remaining portions of the specification and the attached drawings.

### BRIEF DESCRIPTION OF THE DRAWINGS

FIG. 1 is a diagram of a first example embodiment of a system for providing career-related information based on user data, job data, and successful hire data.

FIG. 2 is a flow diagram of a first example method adapted for use with the system of FIG. 1.

FIG. 3 illustrates a first example user interface display screen depicting career-related information generated via the embodiments of FIGS. 1-2.

FIG. 4 illustrates a second example user interface display screen depicting an alternative presentation of career-related information, which may be accessed via the first example user interface display screen of FIG. 3.

FIG. 5 is a flow diagram of a third example method, which may be implemented via the embodiments of FIGS. 1-4.

### DETAILED DESCRIPTION OF EMBODIMENTS

For the purposes of the present discussion, an enterprise may be any organization of persons, such as a business, university, government, military, and so on. The terms “organization” and “enterprise” are employed interchangeably herein. Personnel of an organization or enterprise, i.e., enterprise personnel, may include any persons associated with the organization, such as employees, contractors, board members, and so on.

A job may include any role or position within an enterprise or organization. A job may refer to and be considered to include various tasks that an employee or worker is to perform while participating in the job. Alternatively or in addition, depending upon the usage context, a job may refer to a database object that contains information pertaining to the job or may refer to the job itself. In either case, a job may be identified by a job title, such as project manager, vice president of marketing, sales engineer, and so on. The terms “career,” “position,” “job,” “job position,” “career position,” and “career step” may be employed interchangeably herein.

Career-related information may include any data, measurements, calculations, metrics, suggestions, and/or analysis results pertaining to or related to a career or employment opportunity, career path, and/or job hiring opportunity. This includes information pertaining to a user seeking a particular career and information characterizing previously hired successful employees.

Examples of career-related information include specifications of job scope, required experience and skills, location, organization, other job description data, career search criteria, and so on. Additional examples of career-related information include information pertaining to a user (e.g. employee or prospective employee), such as user knowledge, experience, general qualifications, preferred working hours, preferred organization, preferred benefit options, preferred advancement opportunities, and so on.

Career-related information may also include, for example, information pertaining to steps, tasks, intermediate careers, and so on, that may lead to a given career opportunity. Career-related information may also include, for example, information indicating that a particular manager or hiring entity is seeking persons with particular qualities, e.g., qualifications, experience, previous employer, and so on.

For clarity, certain well-known components, such as hard drives, processors, operating systems, power supplies, administrator interfaces, and so on, are not shown or labeled in the figures. However, those skilled in the art with access to the present teachings will know which components to implement and how to implement them to meet the needs of a given application.

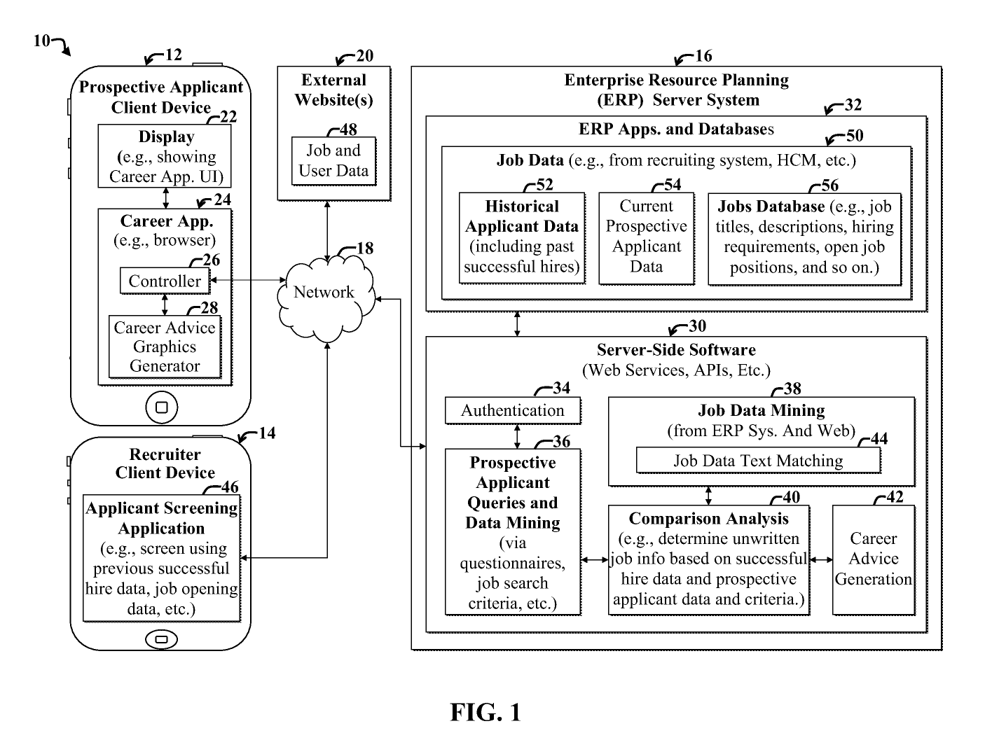

FIG. 1 is a diagram of a first example embodiment of a system 10 for providing career-related information based on user data, job data, and successful hire data. The example system 10 includes a first client device 12, which represents a device employed by a prospective applicant or candidate (called the user herein) for one or more jobs, and a second client device 14, which represents a device employed by a recruiter or advisor. The client devices 12, 14 communicate with an Enterprise Resource Planning (ERP) server system 16 via a network 18, such as the Internet.

In various embodiments discussed herein, a prospective applicant (often called the “user” herein) may be a person seeking a job or information about jobs or career possibilities or otherwise seeking advice as to how to advance in a career or move to another career. Note that in certain cases, the “user” may be a recruiter or employer. Accordingly, the term “user” herein is taken in context to refer to a candidate, recruiter, or employer.

The ERP server system 16 and client devices 12, 14 may communicate with external websites 20, which may contain additional job data and user data 48. The job data and user data 48 may include information pertaining to user qualifications or other job-related characteristics in addition to general information, such as user name, career interests, address, and so on.

The first example client device 12, which may be implemented via a mobile computing device, desktop computer, or other computing device or mechanism, includes a display 22 in communication with a career application 24. The career application 24 includes a controller 26 in communication with a career advice graphics generator 28.

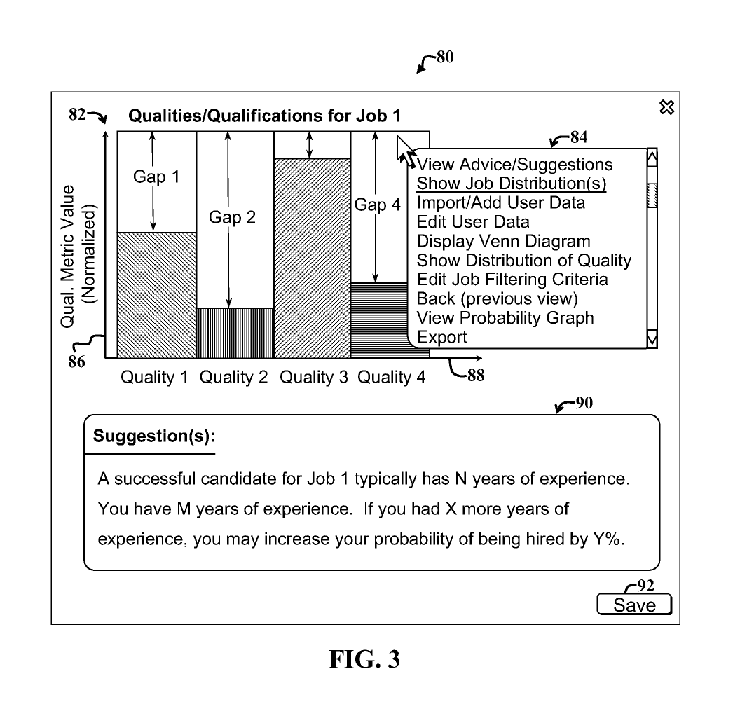

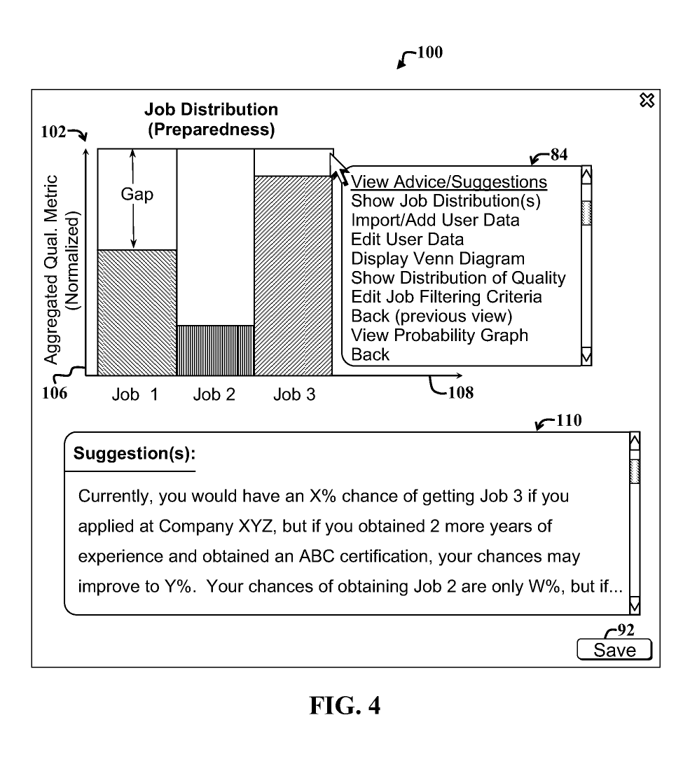

The controller 26 of the career application 24 selectively communicates with server-side career software 30 to facilitate obtaining information to enable to the client-side career advice graphics generator 28 to construct graphics and user interface display screens to be presented via the display 22. The displayed user interface display screens and accompanying graphics may depict or otherwise show career-related information, as discussed more fully below, e.g., with reference to FIGS. 3 and 4.

For the purposes of the present discussion, user data may be any information characterizing or otherwise associated with a user, such as a prospective applicant or candidate for one or more jobs. For example, user data may include job qualifications, such as work experience, education and related degrees, awards, psychological characteristics (e.g., as measured via psychometric analysis), and so on. User data may further include user job preferences, such as location, employer, vacation time allowed, hours worked per week, compensation (e.g., salary), and so on.

The ERP server system 16 includes the server-side software 30, which communicates with various ERP software applications and databases 32, which maintain job data 50. The job data 50 includes historical applicant data 52, current prospective applicant data, i.e., user data 54, and data 56 pertaining to particular jobs, such as whether a job has an opening, what qualifications or competencies are required for the job, and so on.

For the purposes of the present discussion, a job qualification may be any characteristic of a user that may influence whether a user may obtain a particular job or whether a user may be successful at a particular job. A job qualification may influence a likelihood of obtaining a job and/or a likelihood or probability of achieving a performance level or other success measurement during user performance of the job. Examples of possible job qualifications include duration and type of work experience, degrees, certifications, previous employers, particular skills or talents, and so on.

For the purposes of the present discussion, ERP software, such as the ERP applications and databases 32, may be any set of computer code that is adapted to facilitate managing resources of an organization. Example resources include Human Resources (HR), financial resources, assets, employees, and so on, of an enterprise. The terms “ERP software” and “ERP application” may be employed interchangeably herein. However, an ERP application may include one or more ERP software modules or components, such as user interface software modules or components.

The ERP applications and databases 32 may include various applications, such as talent management systems, performance management systems, Human Capital Management (HCM), and so on, which may provide a wealth of data pertaining to available jobs and users (e.g., as maintained via user profiles), including historical employee performance data.

For the purposes of the present discussion, a talent management system or application may be any software application or functionality for facilitating selecting, organizing, or managing enterprise personnel or tasks performed thereby. Personnel of an organization may include any persons associated with the organization, such as employees, contractors, board members, and so on.

Talent management systems, also called personnel management systems, may be employed in various applications, including, but not limited to, hiring enterprise personnel, determining compensation, developing capabilities, utilizing capabilities, facilitating career planning, employee retainment, employee recruitment, and so on.

For the purposes of the present discussion, software functionality may be any function, capability, or feature, e.g., stored or arranged data, that is provided via computer code, i.e., software. Generally, software functionality may be accessible via use of a user interface and accompanying user interface controls and features. Software functionality may include actions, such as retrieving data pertaining to a business object; performing an enterprise-related task, such as promoting, hiring, and firing enterprise personnel, placing orders, calculating analytics, launching certain dialog boxes, performing searches, and so on.

A Human Capital Management (HCM) system, also called a human resource management system, may be any software that is adapted to facilitate managing enterprise personnel. Certain HCM systems are adapted to facilitate hiring, retaining, using and developing capabilities of enterprise personnel, and so on. Note that various types of systems may include other systems. For example certain HCM systems may include talent management systems as components thereof.

The server-side software 30 may employ web services, Application Programming Interfaces (APIs), and so on to facilitate implementing functionality represented by various example modules 34-42. The server-side software 30 includes an authentication module 34, which is adapted to identify and authenticate a user in response to user input of identification information, thereby facilitating determining user access permissions, i.e., what functionality should be accessible to the user via the server-side software 30.

The authentication module 34 may communicate user login and permissions information to other modules of the server-side software 30, including a prospective applicant query and data mining module 36, also simply called the user data mining module 36. The user data mining module 36 communicates with a comparison analysis module 40, which also has access to a job data mining module 38 and a career advice generation module 42.

The user data mining module 36 is adapted to access the current prospective applicant data 54, i.e., enterprise user data 54, which may be maintained via a database, such as a performance management or profile management database. For example, a prospective applicant or candidate for one or more jobs, e.g., a promotion in an enterprise that maintains the ERP sever system 16, may have existing data, such as performance metrics, awards, skill sets, experience, address information, and so on, stored via one or more of the enterprise databases 32. Such information may be maintained, for example, in a worker profile.

Furthermore, the user data mining module 36 may employ one or more web services to selectively access remote user data 48 from user profiles maintained via external websites 20, such as LinkedIn, Facebook, other social networking websites, job-search websites, and so on. For the purposes of the present discussion, user profile information may be any information pertaining to a user, e.g., an enterprise employee, social network user, job-search website account holder, and so on, stored in a database of an organization or enterprise.

Similarly, the job data mining module 38 selectively communicates with the ERP applications and databases 32 to facilitate retrieving historical applicant data 52 and jobs data from the job database 56. The historical applicant data 52 includes information pertaining to past and present enterprise employees, including past successful hires for various jobs, i.e., successful hire data. Furthermore, similar job data and successful hire data may be retrieved from the external websites 20 and aggregated via the job data mining module 38. Such data 48 may be retrieved via the job data mining module 38 and stored among the ERP databases 32 and/or may be stored in a database included in the job data mining module 38.

For the purposes of the present discussion, a successful hire may be any person who has been hired to work at a particular job and who had demonstrated success at the job. A person is said to be successful at a job if one or more job performance metrics associated with the person surpass a predetermined threshold. The predetermined threshold may be any level, such as a default level. The predetermined threshold may be set by an administrator and/or which may be determined via another mechanism. The exact predetermined threshold and the exact job performance metrics used to determine whether a person represents a successful hire are implementation specific and may vary, without departing from the scope of the present teachings.

In certain implementations, instead of or in addition to employing preexisting performance metrics to determine whether a person has demonstrated success at a job, other factors may be considered, such as numbers of awards obtained, whether the person was promoted to a higher position. Furthermore, in certain implementations, a person is considered to demonstrate success at a job by merely being hired to work at the job. Accordingly, in such implementations, a successful hire may be any person that has previously been hired to work at a given job.

Successful hire data may be any data pertaining to or otherwise characterizing or associated with a successful hire. For example, successful hire data may include indications of job qualifications, including work experience, education and related degrees, awards, psychological characteristics (e.g., as measured via psychometric analysis), performance metrics, and so on.

The job data mining module 38 includes a job data text matching module 44, which includes computer code for enabling matching job search criteria and user data, which may have been provided by a user via the career application 24 and accompanying user interface functionality, with job information retrieved via the job data mining module 38. For example, if a user searches for a software development job and provides a job description along with the search query, then electronic text included in the job description may be matched with electronic text (and equivalents) included among job information retrieved by the job data mining module 38 and/or maintained in the jobs database 56 and/or external websites 20.

For the purposes of the present discussion, electronic text may be any electronic representation of one or more letters, numbers or other characters, and may include electronic representations of natural language, such as words, sentences, and so on. The terms “electronic text” and “text” are employed interchangeably herein.

The comparison analysis module 40 communicates with the user data mining module 36, the job data mining module 38 and a career advice generation module 42. The comparison analysis module 40 includes computer code for employing user data from the user data mining module 36 and both job data and associated successful hire data from the job data mining module 38 to determine qualification gaps. The qualification gaps may represent gaps between qualifications of a user and those of successful hires for jobs that have been selected based on initial search criteria provided by a user via the client-side career application 24. The comparison analysis module 40 may also compute analysis metrics, such as estimates of probabilities of a user obtaining a particular job if the user applied for the job now or after obtaining certain additional qualifications.

Furthermore, the data mining modules 36, 38 and the comparison analysis module 40 may include computer code for normalizing data and terms for comparison purposes. For example, the job data text matching module 44 may include a synonym library for normalizing certain words and job titles by associating the terms and job titles or descriptions with each other and/or with a single job title. As another example, the comparison analysis module 40 may include computer code for selectively scaling different types of performance metrics to fit within a particular scale of another performance metric to facilitate comparison analysis and generation and display of career-related information, e.g., via one or more visualizations and/or natural language output.

For the purposes of the present discussion, natural language output may be any instruction or information provided via spoken or written (e.g., typed) human language. Examples of language output usable with certain embodiments discussed herein include voice commands, text messages (e.g., Short Message Service (SMS) text messages), emails containing text, direct text output in a career application user interface display screen, and so on.

Comparison information, e.g., pertaining to qualification gaps, is accessible to the career advice generation module 42 via the comparison analysis module 40. In the present example embodiment, the career advice generation module 42 includes computer code, including natural language processing code, for generating natural language suggestions to be displayed to a user, e.g., via the display 22 and career application 24 of the first user device 12.

For the purposes of the present discussion, a data comparison, e.g., as performed by the data comparison analysis module 40, may be any act or task involving juxtaposing or analyzing different data elements or data sets or measurements or metrics derived therefrom with respect to other data elements or data sets or measurements or metrics derived therefrom. Comparison results may be any results of a data comparison, such as information indicating differences between the data sets and/or elements compared. Furthermore, in cases where a measurement of a first data set is compared with a measurement of a second data set, the first data set is still said to be compared to the second data set. Note that various modules 34-42 of the server-side software 30 may be accessed via the client-side career application module 24.

A qualifications gap, also called a competency gap herein, may be any dearth or lack of a particular skill, knowledge, performance metric, or other qualification of a person, such as a job candidate or other user of an embodiment disclosed herein. A metric may be any measurement, parameter, or other indicator associated with a person or thing. Examples of metrics include sales performance scores, quota attainment numbers, versatility measurements, and so on.

The second client device 14 includes an applicant screening application 46. The applicant screening application 46 includes computer code for employing successful hire data and job opening data to provide suggestions to recruiters looking to fill particular jobs, i.e., to connect qualified prospective applicants with possible job openings. For example, the recruiter may know certain employers that are seeking new hires that are similar to those who have demonstrated success working with the employers. The applicant screening application 46 is adapted to selectively access the server-side software 30 to facilitate finding prospective applicants, i.e., candidates whose data (i.e., “user data”) matches or otherwise indicates that the candidates are associated with a given probability of being successful when working at a particular job offered by one or more employers.

Note that either of the client devices 12, 14 may act as administrator devices with accompanying administrator user interfaces, when the users of the devices 12, 14 login and are authenticated by the authentication module 34 and granted administrator privileges. In certain embodiments, administrator user interface software functionality running on the client devices 12, 14 and/or the ERP server system 16 may enable an administrator to adjust various parameters of the server-side software 30, such as, calculation methods (e.g., for estimating probabilities of candidates acquiring jobs), probability thresholds (e.g., for selecting candidates and associated user data to be forwarded to an employer), questions to be included in questionnaires for collecting job search criteria and user data, and so on, of the server-side software 30.

Note that various modules and groupings of modules shown in FIG. 1 are merely illustrative and may vary, without departing from the scope of the present teachings. For example, certain components shown running on the client system 12 may instead be implemented on a computer or collection of computers that accommodate the ERP server system 14. Furthermore, certain modules may be implemented via a single machine or may be distributed across a network.

Furthermore, various modules may be omitted from the system 10 or combined with other modules, without departing from the scope of the present teachings. For example, in certain implementations, the controller 26 may be implemented as part of the server-side software 30.

For example, in certain implementations, job data, user data, successful hire data, and so on may be retrieved to a client device for use by a client-side application to perform data comparison analysis to determine qualifications gaps and to generate natural language suggestions in response thereto. In this case, the data comparison analysis 40 module would be implemented client side, as opposed to server-side. Furthermore, requisite data may be selectively pushed to the client-side application based on one or more data subscriptions.

Those skilled in the art with access to the present teachings may employ readily available technologies to facilitate implementing an embodiment of the system 10. For example, Service Oriented Architectures (SOAs) involving use of Unified Messaging Services (UMSs), Business Intelligence Publishers (BIPs), accompanying web services and APIs, and so on, may be employed to facilitate implementing embodiments discussed herein, without undue experimentation.

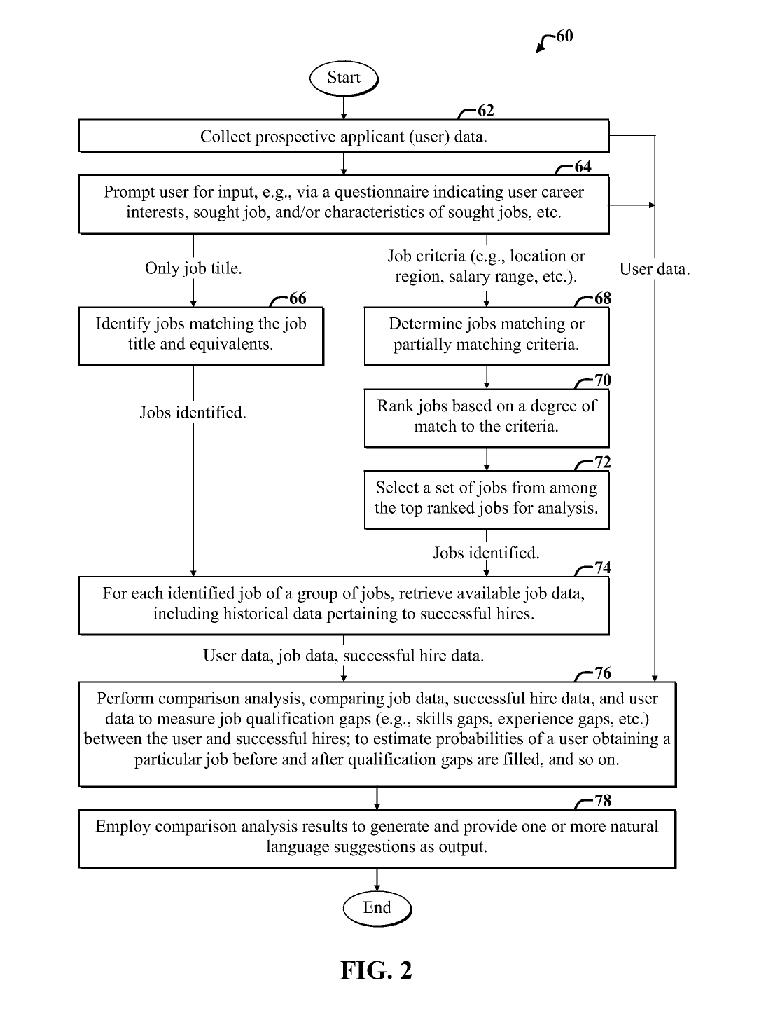

FIG. 2 is a flow diagram of a first example method 60 adapted for use with the system 10 of FIG. 1. With reference to FIGS. 1 and 2, the method 60 includes an initial user-data collection step 62, which involves collecting user authentication information, i.e., identification information (e.g., login credentials), and employing the resulting user identification information to retrieve user data, e.g., from the ERP databases 50 and external websites 20. User identification information and any additional user information may be provided, for example, via the client-device 12 and accompanying career application 34 and user interface features (e.g., the display 22).

The user data may include user name, specifications of job qualifications, e.g., skills, experience, and so on. The collected user data may be harvested from worker profile information corresponding to the user and maintained via an ERP database, such as one or more of the ERP databases 32 of FIG. 1.

For the purposes of the present discussion, worker profile information may be any information stored in a database of an organization or enterprise, wherein the information includes career-related information pertaining to the worker. Enterprise software, such as Human Capital Management (HCM) systems often store information about employees or other workers in computing objects or records called profiles.

A subsequent prompting step 64 is adapted to collect additional user information, including any job search criteria, via use of a questionnaire. An example questionnaire provides user options for indicating user career interests, indicating a particular sought job, e.g., by specifying one or more job titles or descriptions, and/or other characteristics. For example, a user may specify, e.g., via the questionnaire, that they are seeking jobs with a particular salary range, within a particular region, and jobs asking for a particular type of job certification, and so on.

Hence, various job-related user preferences may be specified in the questionnaire answers. For the purposes of the present discussion, a job-related preference may be any indication of a preferred characteristic of a job or career opportunity. For example, a job-related preference may be an indication that a user prefers to work with a particular organization.

Note that other user interface mechanisms other than questionnaires may be employed to enable a user to enter job search criteria, without departing from the scope of the present teachings. For example, a questionnaire may be replaced with a set of form fields or other mechanisms for enabling a user to enter information and job search criteria. Furthermore, in certain implementations, the prompting step 64 may be omitted, and an initial set of job search criteria may be automatically determined, e.g., by the client-side career application 24 and server-side software 30 based on data obtained in the initial user-data collection step 62.

As another example, the questionnaire may be replaced via an input field, whereby a user may specify natural language input, which is then processed, e.g., via a natural language processor, to determine job criteria and other parameters used to generate career-related advice. A user might use such a field to specify, for example “The following are my qualifications: 5 years of software development experience; graduate computer science degree. What job am I suited for?” As another example, a user might specify: “Please provide advice as to how I can obtain a job similar to what I am currently doing, but that pays more than X.”

If in response to the prompting step 64, a user only specifies a search for a particular job title, then a first job-identification step 66 is performed. Otherwise, a series of job-identification steps 68-72 are performed.

The first job-identification step 66 includes identifying a set of one or more jobs matching the specified job title and/or equivalents. For example, a job title of “software developer” may be considered as equivalent to a “software programmer” in certain implementations.

If in response to the prompting step 64, the user provides additional job search criteria, such as location or region, salary range, and so on, the series of job-identification steps 68-72 are performed. A jobs-matching step 68 may include employing text matching to determine jobs (and associated job descriptions and other job information obtained via the job data mining module 38 of FIG. 1) that match or partially match the job search criteria (also simply called job criteria herein).

The degree to which job data associated with a job matches the job criteria may be determined via a scoring algorithm. Exact details of the scoring algorithm are implementation specific and may vary, without departing from the scope of the present teachings. Those skilled in the art with access to the present teachings may readily develop or obtain a search result ranking system and associated scoring algorithm sufficient to meet the needs of a given implementation and without undue experimentation.

A subsequent job-ranking step 70 includes ranking the jobs identified in the job-matching step 68 in accordance with a score, which may be reflective of a degree of match between the job and associated job data with the specified job criteria.

Next, a predetermined number of top ranking jobs is selected for analysis in a job-selection step 72. For example, the top ten jobs matching the job criteria may be selected for inclusion in a group of selected jobs. The exact number of jobs selected for analysis is implementation specific and may vary, depending upon the needs of a given implementation. For example, in certain implementations, the number of jobs selected for use in subsequent analysis may be user configurable. In such cases, a user interface display screen may provide one or more user options for specifying a maximum or minimum number of jobs to select for the purposes of comparison analysis.

After information specifying identified jobs matching search criteria is obtained, an additional data-retrieval step 74 is performed. The data-retrieval step 74 includes retrieving available job data for each identified job. In the present example embodiment, the retrieved job data includes successful hire data, i.e., historical data pertaining persons who represent or represented successful hires for one or more jobs of the jobs identified via the job-identifying step 66 and/or series of job-identifying steps 68-72.

Subsequently, user data, job data, successful hire data, and so on, obtained via the additional data-retrieval step 74, is used by a comparison-analysis step 76.

In the present example embodiment, the comparison-analysis step 76 includes performing comparison analysis by comparing job data, successful hire data, and user data to measure job qualification gaps (e.g., skills gaps, experience gaps, etc.) between the user and successful hires and to estimate probabilities of a user obtaining a particular job before and after qualification gaps are filled. Note that different or additional types of comparison analysis may be performed without departing from the scope of the present teachings.

Results of the comparison-analysis step 76, i.e., comparison results, are then employed by a suggestion-generation step 78. The suggestion-generation step 78 includes generating natural language suggestions and/or visualizations for depicting or otherwise communicating career-related information, such as suggestions or advice.

FIG. 3 illustrates a first example user interface display screen 80 providing career-related information 82, 90 generated via the embodiments of FIGS. 1-2, via a visualization 82 and natural language suggestions 90.

For the purposes of the present discussion, a user interface display screen may be any software-generated depiction presented on a display. Examples of depictions include windows, dialog boxes, displayed tables, and any other graphical user interface features, such as user interface controls, presented to a user via software, such as a browser. A user interface display screen contained within a single border is called a view or window. Views or windows may include sections, such as sub-views or sub-windows, dialog boxes, graphs, tables, and so on. In certain cases, a user interface display screen may refer to all application windows presently displayed on a display.

The visualization 82 (also called a qualification bar chart) represents a graphical depiction of analytics. For the purposes of the present discussion, an analytic may be any calculation or measurement based on a given input. Certain analytics may be displayed graphically. For example, an analytic that calculates a degree of a match between a user and a candidate position based on information about the user and various candidate positions may be displayed via a bar chart, such as the qualification bar chart 82. In general, a graphically displayed analytic or other visual representation of data is called a visualization herein.

In the present example embodiment, the visualization 82 plots normalized quality metric value 86 versus quality 88. Each quality (qualities 1-4) represents a particular qualification associated with the user and associated with particular job (e.g., Job 1). The total heights of each bar are normalized to correspond to qualification levels associated with a highest estimated probability of obtaining the job (Job 1) based on a quality or qualification distribution of successful hire data. Sub bars (shaded) within each bar indicate qualification levels associated with the user, such that differences between sub bar heights and total bar heights illustrate qualification gaps.

For example, the first quality may represent experience. A difference between the user's experience level and an experience level associated with a highest likelihood of becoming a successful hire appears as a gap (Gap 1). In this way, a user may quickly see where the user's qualifications or qualities differ from data derived from successful hires.

The various gaps illustrated via the visualization 82 represent qualification gaps, also called competency gaps herein, as measured via metrics. For the purposes of the present discussion, a competency gap may be any dearth or lack of a particular skill, knowledge, or performance metric of a person, such as an employee or other user of an embodiment disclosed herein. A metric may be any measurement, parameter, or other indicator associated with a person or thing. Examples of metrics include sales performance scores or quota attainment numbers, versatility measurements, and so on.

An example right-click menu 84 provides various additional user options for manipulating or changing displayed visualizations, editing data, and so on. For example, user options provided via the drop-down menu 84 include an option to view advice/suggestions for a particular qualification (e.g., quality 4); to show job distributions (e.g., a distribution of jobs versus aggregated qualification measurements); to import and/or otherwise add additional user data; to edit user data; to display a Venn diagram (e.g., depicting different groups of successful hire qualifications and showing any overlap between a user's qualifications and groups of successful hire qualifications for jobs matching search criteria); to show a distribution of quality (e.g., a diagram depicting numbers of successful hires versus a given quality or qualification metric); to edit job criteria or filtering criteria; to return to a previous view; to view a probability graph (e.g., depicting probabilities of a user obtaining different jobs); to export information in the visualization 82, e.g., to a database and/or website, and so on.

Note that different or additional user options are possible, without departing from the scope of the present teachings. For example, a user option may enable changing the type of the visualization 82 (e.g., to a pie chart, spider chart, or other type of visualization). Another user option may enable drilling down into different portions of the visualization 82 to reveal additional information underlying each portion of the visualization 82, and so on.

In certain implementations, user options provided via the drop-down menu 84 may be context sensitive, such that they change depending upon where the user right-clicks in the visualization 82 to activate the drop-down menu 84.

In the present example embodiment, initial natural language suggestions 90 are automatically provided for a job (e.g., Job 1) associated with the visualization 82. The career advice generation module 42 may include artificial intelligence algorithms and/or a collection of statements with data insertion fields to facilitate generating the natural language suggestions 90. Those skilled in the art with access to the present teachings may readily develop or otherwise obtain natural language advice generation software suitable for use with particular implementations of embodiments, without undue experimentation.

Furthermore, note that certain job qualifications, e.g., skill sets, may be more important for certain jobs. Artificial intelligence algorithms may be employed to selectively weight the importance of different skill sets or to otherwise normalize the associated qualification metrics accordingly, so as to facilitate generating natural language advice and providing informative visualizations, such as the visualization 82.

Examples of other natural language suggestions include:

1. “A successful candidate typically has N years of experience, and you have 8 years. If you had 3 years more experience, you may increase your chances of being hired by 50%.”

2. “Even if you did X, you would have a 10% chance of getting the job, but it would be an improvement, considering that your chances are currently at Y %.”

3. “You currently have 5 years of experience and a level 2 qualification, and it's estimated that you have a 10% chance of getting the job. If you acquired 2 more years of experience and a level 4 certification, your chances of getting the job may increase to 40%.”

4. “You currently have 5 years of experience and an X job certification level, but the job that you are seeking is typically hiring people with 7 years of experience and an X+1 job certification level. The system advises you to meet the next certification level.”

Note that other types of information visualizations and output mechanisms are possible for conveying career-related information that incorporates successful hire data. For example, if a user selects a “Show Job Distribution(s)” option from the drop-down menu 84, another visualization may appear showing a plot of aggregated user qualification levels versus different jobs, as discussed more fully below with reference to FIG. 4.

FIG. 4 illustrates a second example user interface display screen 100 illustrating a second visualization 102 of career-related information, which may be accessed via the first example user interface display screen 80 of FIG. 3.

The user interface display screen 100 includes a job distribution plot 102, which illustrates normalized and aggregated metrics 106 for job qualifications associated with successful hires versus different jobs 108 (e.g., Jobs 1-3) in combination with corresponding aggregated normalized qualification metrics for the user.

For example, with reference to the second visualization 102, the user may see that the sum of their qualification metrics (e.g., corresponding to experience, skill levels, performance values, etc.) indicate they may be most suitable for obtaining Job 3, since their aggregated skills gap is the smallest for Job 3.

Additional natural language suggestions 110 may be updated to account for the context, i.e., information currently displayed via the second visualization 102. For example, the natural language suggestions 110 may include advice that may be applicable to the user in view of the different jobs (e.g., Jobs 1-3) and associated successful hire data.

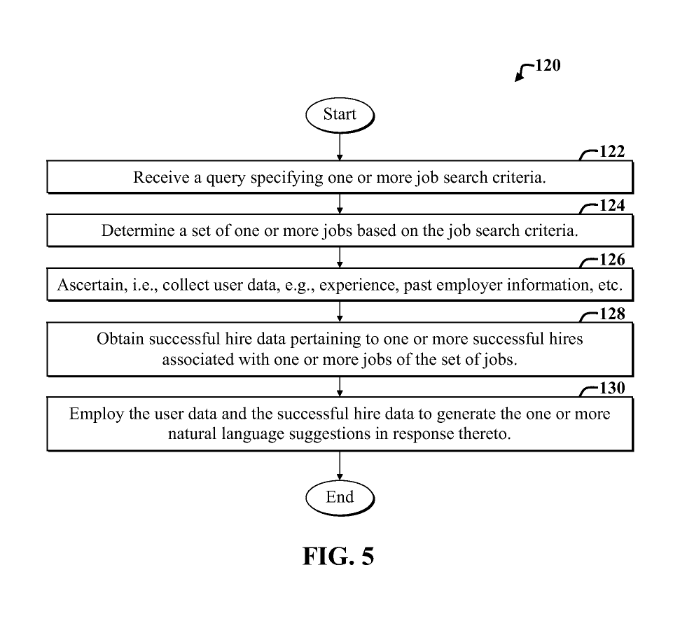

FIG. 5 is a flow diagram of a third example method 120, which may be implemented via the embodiments of FIGS. 1-4. The third example method 120 is adapted to facilitate selectively providing career-related information and includes a first step 122, which involves receiving a query specifying one or more job search criteria.

A second step 124 includes determining a set of one or more jobs based on the job search criteria.

A third step 126 includes ascertaining, i.e., obtaining or otherwise accessing or retrieving user data, i.e., data, such as profile data pertaining to a prospective job applicant or candidate.

A fourth step 128 includes obtaining successful hire data pertaining to one or more successful hires associated with one or more jobs of the set of jobs.

A fifth step 130 includes employing the user data and the successful hire data to generate the one or more natural language suggestions in response thereto.

Note that present example method 120 is merely illustrative and may vary, without departing from the scope of the present teachings. For example, a more generalized method, which may encompass use of the system of FIG. 1 by recruiters and other persons; not merely a user who is a prospective applicant or candidate for one or more jobs, includes determining a first set of one or more jobs based on one or more criteria; accessing successful hire data pertaining to one or more jobs of the first set of one or more jobs; and employing the successful hire data to provide one or more natural language suggestions in response thereto. The successful hire data includes data characterizing one or more persons that have been previously hired to the one or more jobs and who is associated with a performance metric that surpasses a threshold.

Although the description has been described with respect to particular embodiments thereof, these particular embodiments are merely illustrative, and not restrictive. For example, while the present application is discussed with respect to systems and methods for providing career-related information to employees, prospective employees, and employers of an enterprise that employs Enterprise Resource Planning (ERP) software, and recruiters, embodiments are not limited thereto. For example, any organization, website, or other entity may implement an embodiment in accordance with the present teachings without employing preexisting ERP software.

Furthermore, while various example user interface display screens discussed herein are directed to employees or prospective employees, various different or additional user interface display screens may be implemented, such as interface display screens directed specifically toward employers or prospective employers, system administrators, and so on, without departing from the scope of the present teachings. Furthermore, certain embodiments may be tailored specifically for facilitating employee recruitment or specifically toward facilitating user career advancement, without departing from the scope of the present teachings.

In addition, while various embodiments discussed herein employ career-related user data, successful hire data, and so on, pertaining to particular job qualifications, embodiments are not limited thereto. Any type of data that may impact user selection of a job or employer selection of a job candidate may be used with embodiments, without departing from the scope of the present teachings. For certain implementations may employ psychometric data to measure personality characteristics of users to facilitate retrieving job data for analysis and for generating career suggestions or advice. Other implementations may accommodate broad or esoteric job search criteria, such as user interests in a particular type of working environment, e.g., available social activities, numbers of breaks allowed, vacation time allowed, and so on.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A method comprising:
determining a first set of one or more jobs based on one or more criteria;
accessing successful hire data pertaining to one or more jobs of the first set of one or more jobs; and
employing the successful hire data to provide career-related information, wherein the successful hire data includes data characterizing one or more persons that have been previously hired to the one or more jobs and who are associated with one or more performance metrics that surpass a threshold.

2. The method of claim 1, wherein the career-related information includes one or more natural language suggestions.

3. The method of claim 1, further including
receiving a query specifying one or more job search criteria;
determining a set of one or more jobs based on the job search criteria;
ascertaining user data;
obtaining successful hire data pertaining to one or more successful hires associated with one or more jobs of the set of jobs; and
employing the user data and the successful hire data to generate one or more natural language suggestions in response thereto.

4. The method of claim 3, wherein employing further includes:
comparing the user data with the successful hire data and providing comparison results in response thereto; and
using the comparison results to provide the one or more suggestions in response thereto.

5. The method of claim 4, wherein the one or more suggestions include natural language output providing instructions to a user indicating how the user may become better qualified to become a successful hire for a particular job.

6. The method of claim 5, wherein the natural language output includes an estimate of a probability that the user will be hired for a particular job currently and after a user obtains additional job qualifications specified via the one or more suggestions.

7. The method of claim 4, wherein the job search criteria includes a job description.

8. The method of claim 7, wherein the job search criteria includes user input responsive to a questionnaire.

9. The method of claim 8, wherein the user data includes the search criteria.

10. The method of claim 8, wherein determining a set of one or more jobs includes employing text matching to match words included among the search criteria with text associated with each job being searched, and selectively including an indication of a job among search results in response to the text matching.

11. The method of claim 3, wherein ascertaining user data includes retrieving data pertaining to one or more characteristics of the user from an enterprise database.

12. The method of claim 11, wherein user data retrieved from the enterprise database includes an indication of one or more job qualifications of the user.

13. The method of claim 3, wherein ascertaining user data includes retrieving data pertaining to one or more characteristics of the user from one or more websites that include a user profile containing career-related information pertaining to the user, wherein the career-related information includes an indication of one or more user job qualifications.

14. The method of claim 3, wherein obtaining successful hire data includes accessing one or more databases that store historical information pertaining to employee performance.

15. The method of claim 14, wherein the successful hire data includes one or more indications of a level of qualification of a person who has been hired to work at a job and who has exhibited a performance, as measured via a performance metric, that exceeds a threshold.

16. The method of claim 4, wherein the comparison results include an indication of a qualification gap between one or more qualifications of the user and one or more qualifications of one or more successful hires, and wherein the method further includes estimating a qualification level most likely to result in the user being hired to a job based on a distribution of qualification levels of successful hires.

17. The method of claim 3, further including determining a first value of a job qualification associated with a user and a second value of a job qualification associated with one or more successful hires, and displaying a visualization depicting a difference between the first value and the second value.

18. The method of claim 3, further including providing a user option to display a second visualization indicating one or more jobs of the first set of one or more jobs in association with one or more measurements of job qualifications of a user and one or more measurements of job qualifications of one or more successful hires.

19. An apparatus comprising:
a digital processor coupled to a display and to a processor-readable storage device, wherein the processor-readable storage device includes one or more instructions executable by the digital processor to perform the following acts:
determining a first set of one or more jobs based on one or more criteria;
accessing successful hire data pertaining to one or more jobs of the first set of one or more jobs; and
employing the successful hire data to provide one or more natural language suggestions in response thereto.

20. A processor-readable storage device including instructions executable by a digital processor for modifying a workplace decision-making hierarchy, the processor-readable storage device including one or more instructions for:
determining a first set of one or more jobs based on one or more criteria;
accessing successful hire data pertaining to one or more jobs of the first set of one or more jobs; and
employing the successful hire data to provide one or more natural language suggestions in response thereto.
